(19) United States
(12) Patent Application Publication
(10) Pub. No.: US 2026/0213937 A1
(43) Pub. Date: Jul. 23, 2026

(54) CORRELATING SECRET ALLOCATIONS, USE AND EXPOSURE

(71) Applicant: MICROSOFT TECHNOLOGY LICENSING, LLC, Redmond, WA (US)

(72) Inventors: Michael Christopher FANNING, Redmond, WA (US); Anthony F SMITH, Redmond, WA (US); Yan SUI, Redmond, WA (US); Ross WOLLMAN, Redmond, WA (US); Nguyen Song Khanh VU, Woodenville (CA)

(21) Appl. No.: 19/035,703

(22) Filed: Jan. 23, 2025

(51) Int. Cl. H04L 9/08; H04L 9/32; H04L 9/40

(52) U.S. Cl. CPC H04L 9/0894; H04L 9/0861; H04L 9/32; H04L 63/1425; H04L 63/1441

(57) ABSTRACT

Cross-correlating identifiers are created and stored in a security asset database for corresponding security assets. The security asset database is used with the cross-correlating identifiers to perform functions for the underlying security assets without exposing the security assets. One function is a scan of network resources for potential exposure of the security assets. A key generation algorithm used to generate the cross-correlating identifiers is applied to any identified potential security data to generate a corresponding reference identifier. A determination is made whether a security asset comprises a security risk that exceeds a predetermined threshold based on at least a determination of whether the cross-correlating identifier for the security asset matches any reference identifiers generated for the potential security data, as well as based on other data stored in the security asset database for the security asset.

### BACKGROUND

Security asset management includes inventory, utilization, exposure and administration of security assets, such as account credentials, passwords, and cryptographic keys used to control access to protected software and hardware resources.

Significant challenges are associated with the management of security assets, including the deployment and monitoring of secrets across different entities and systems, as well as the replacement of security assets that become compromised or inoperable.

Security assets can become compromised and exploitable, for example, by malware, the sharing of secret information with unauthorized entities, and the transmission of secret information through insecure channels. Security assets, compromised or not, may also become incompatible due to system upgrades and/or changes made to the access control requirements associated with the resources that are protected by the secret assets.

These and other security management issues can complicate and frustrate the processes involved with identifying security risks and implementing remedial actions, such as invalidating existing security assets and redeploying new security assets.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

Disclosed and claimed embodiments include systems, methods and devices for facilitating security asset management with the utilization of a security asset database that stores information associated with security assets that are used to control access to protected resources.

In some aspects, computing systems and methods are provided for generating and managing cross-correlating identifiers stored in the security asset database for corresponding security assets along with other information associated with the referenced security assets.

The security asset database is used with the cross-correlating identifiers to perform functions for the underlying security assets without exposing the security assets. One disclosed function is a scan of network resources for potential security data having patterns matching one or more predetermined security data patterns. Subsequently, a key generation algorithm is applied to the identified potential security data to generate one or more corresponding reference identifier(s). A determination is then made whether a stored security asset comprises a security risk that exceeds a predetermined threshold based at least in part on a determination of whether the corresponding cross-correlating identifier for the security asset matches the generated reference identifier(s) of the identified potential security data.

In some aspects, a security risk of a security asset referenced in the security asset database is additionally, or alternatively, based on other data stored in the security asset database, such as but not limited to the type and age of the security asset.

In some aspects, in response to determining a security risk of a security asset exceeds a predetermined risk threshold, the disclosed systems and methods trigger one or more remedial actions. Remedial actions include, in some instances, generating a notification to one or more entities associated with a security asset, providing instructions for replacing the security asset, replacing the security asset with a new security asset in the security asset database, and/or generating and storing a new cross-correlating identifier for the new security asset.

In some aspects, even when a determination is made that the generated reference identifiers of the potential security data fail to match the cross-correlating identifier for a stored security asset, remedial action for replacing the security asset is still triggered based on a determination that the security risk of the security asset exceeds a predetermined security risk threshold, and notwithstanding the cross-correlating identifier of the security asset failing to match the generated reference identifiers of the potential security data.

In some aspects, computing systems include one or more hardware processors and hardware storage storing computer-executable instructions that are executable by the hardware processor(s) to implement the functionality and methods disclosed herein.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates a computing environment in which a security asset manager manages security assets with a security asset database utilizing cross-correlating identifiers.

FIG. 2 illustrates an example of a security asset database containing security asset information, including security asset values and cross-correlating identifiers.

FIG. 3 illustrates a process flow diagram for managing security assets with cross-correlating identifiers.

FIG. 4 illustrates a flowchart of acts associated with example methods for managing security assets with cross-correlating identifiers.

FIG. 5 illustrates an example computer system that includes and/or that may be used to implement the disclosed embodiments.

### DETAILED DESCRIPTION

Disclosed and claimed embodiments include systems, methods and devices for facilitating security asset management with the utilization of a security asset database that stores information associated with security assets and which security assets are identifiable by corresponding cross-correlating identifiers.

The term security asset should be broadly construed, unless otherwise stated, to include any type of account credential, password, token, certificate, cryptographic key and/or any other data used to control access to protected software and/or hardware resources. The referenced security assets can be generated as different types of data and can be stored in different formats to control access to protected resources.

In some embodiments, computing systems and methods are provided for generating security asset databases (e.g., indexes, tables, or other data structures) that include cross-correlating identifiers for the security assets, as well as other information that corresponds to the security asset (e.g., ownership, type, age, use, status) without exposing the actual security assets. In this manner, the security asset databases and cross-correlating identifiers can be used to perform functions for the underlying security assets without exposing the security assets. A separate index that identifies the actual security asset and that correlates the security asset to the cross-correlating identifiers can be stored in a security vault where the security asset secrets are not exposed or shared.

The referenced cross-correlating identifiers are strong identifiers comprising transformed representations (e.g., hash identifiers) of the security assets and are generated by applying one or more key generation algorithm(s) to the security assets.

In some implementations, the referenced security assets and cross-correlating identifiers are stored in security asset databases (e.g., Azure Key Vault) which may be managed by enterprise and third-party administrators.

Beneficially, the disclosed embodiments can be utilized to provide various technical improvements in the technical field of security asset management. In particular, the disclosed and claimed embodiments can be utilized to facilitate the use of cross-correlating identifiers associated with secret assets in a manner that is useful for identifying potential security risks associated with the secret assets based on patterns in scanned data that matches the cross-correlating identifiers of the security assets and without exposing the underlying security assets.

The cross-correlating identifiers can also be used to generate notifications to scanning systems and managers of the security assets without having to actually transmit a copy of the actual security assets referenced by the cross-correlating identifiers in all communications associated with or referencing the security asset. This represents a technical benefit and improvement over traditional secret management systems by helping to maintain the secrecy and security of the secret assets. In particular, the transmission and use of the cross-correlating identifiers, even if exposed during communication or use, will not expose the underlying security asset. In this manner, the disclosed techniques for utilizing the cross-correlating identifiers can help reduce the need to generate and deploy new replacement security assets to replace secret assets that might otherwise become exposed and compromised when traditional security management systems transmit and use the actual security assets during scanning and communication processes associated with the security assets.

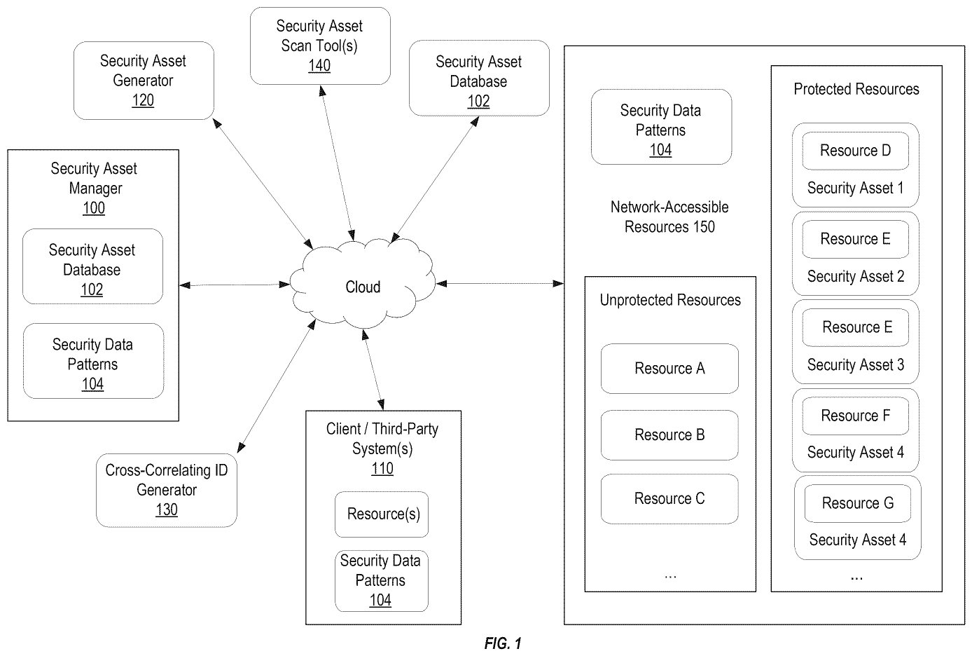

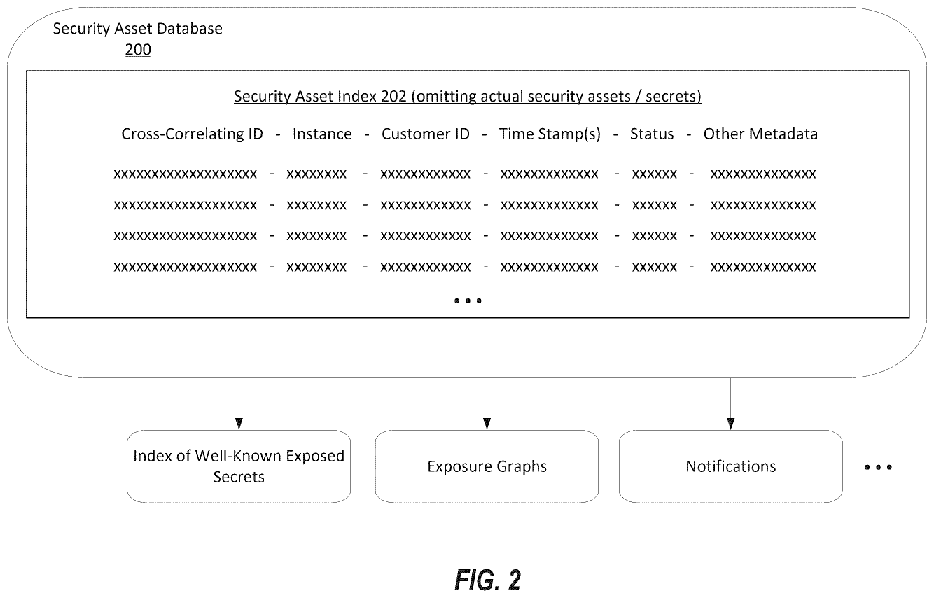

FIG. 1 illustrates a computing environment in which a security asset manager 100 manages a security asset database 102 containing security assets, cross-correlating identifiers corresponding to the security assets, and other information associated with the security assets, as will be described in more detail, below, in reference to FIG. 2.

The security asset manager 100 may also store and/or have access to security data patterns 104. The security data patterns 104 may be stored locally and/or remotely from the security asset manager 100, such as by being stored in client and/or third-party system(s) 110 as a network resource accessible through the cloud. The cloud is defined herein to include a combination of wireless and/or wired network systems.

The security assets referenced in the security asset database 102 are used to control access to protected resources (e.g., Resource D, Resource E, Resource F and Resource G) of client and third-party system(s). These protected resources can include files, applications, services, and other software, as well as hardware components.

In some instances, a single security asset (e.g., Security Asset 4) can be used to control access to multiple resources (e.g., Resource F and Resource G), such as a client credential used to access several different client files and systems.

In some instances, a single resource (e.g., Resource E) can also be securely accessible with different security assets (e.g., Security Asset 2 and Security Asset 3), such as when granting different employees, each having different login credentials, shared access to a single enterprise file or application.

The Security Asset Manager 110 utilizes a security asset generator 120 to access or obtain the security assets that are used to control access to protected resources. In some instances, the security asset generator 120 provides interfaces that are presented to users to prompt the users for credentials, passwords or other security information that is used as the security asset generator 120 to generate the saved instance of the security asset that is stored in the security asset database 102. In these embodiments, the security asset is a string of data provided as user input.

In some instances, the security asset generator 120 automatically generates a random key that comprises the security asset, such as in response to a user command. In other embodiments, the security asset is obtained from a client or third-party system in a communication that identifies the security asset, preferably over a secure communication channel.

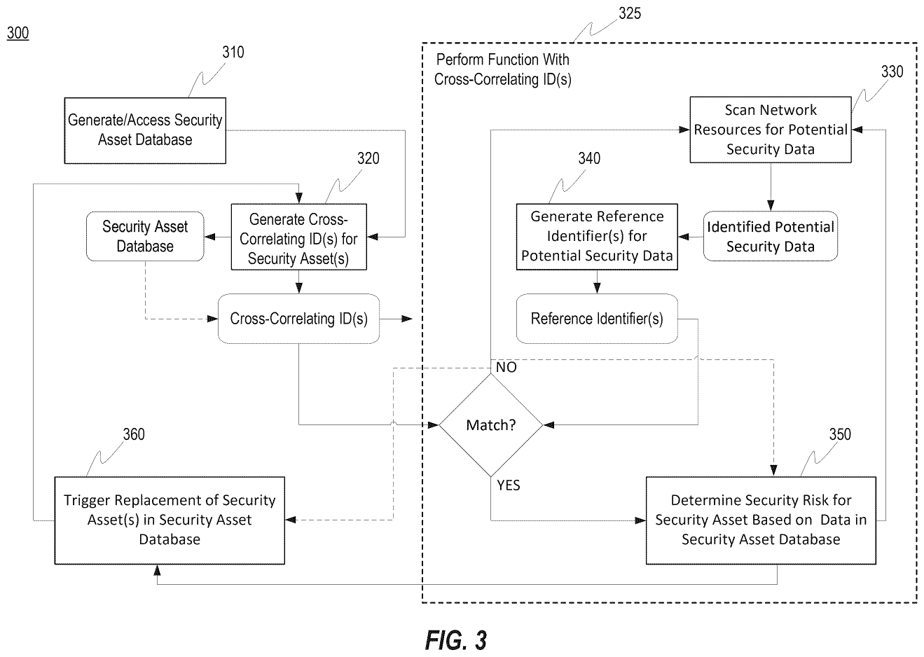

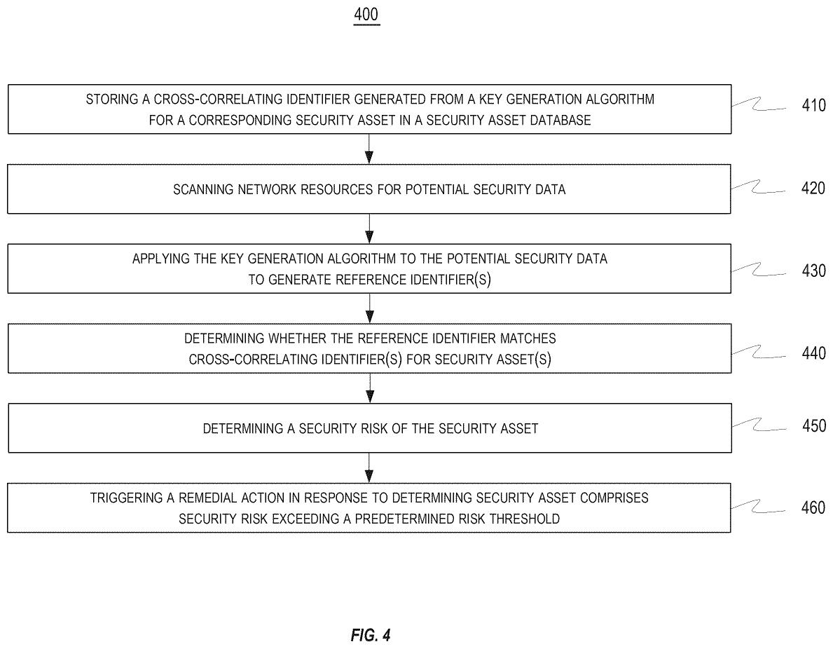

Once a security asset is obtained or otherwise identified, the security asset manager generates and stores a copy of a cross-correlating identifier of the security asset in the security asset database 200 with other information associated with the security asset, such as shown by the example security asset database 200 of FIG. 2. Importantly, the security asset database 200 omits the actual security assets in some instances, only referencing the underlying security assets by their cross-correlating identifiers. This enables the security asset database 200 to be used to perform processes for the security assets with the cross-correlating identifiers and without exposing the underlying security assets (e.g., secret passwords and credentials). One use of the security asset database 200 and cross-correlating identifiers, for example, is to perform a security scan of network resources for potential risks and exposure of the underlying security assets, as shown and described in more detail below regarding FIGS. 3-4.

Another process that can be performed with the cross-correlating identifiers includes the the generation of an index of well-known exposed secrets, which is built from and/or that references the cross-correlating identifiers of exposed security assets and without having to further expose the underlying security assets.

Another process that can be performed with the cross-correlating identifiers includes the generation of exposure graphs that identify the extent of potential exposure of a security asset in network resources and the dependencies of those resources. The exposure graphs can reference the cross-correlating identifiers without having to further expose the underlying security assets. These exposure graphs can be useful for research and testing security vulnerabilities without exposing the underlying security asset secrets.

Another process that can be performed with the cross-correlating identifiers includes the generation of notifications for end users, managers and administrators associated with the security assets, without having to communicate the actual secrets of the actual security assets and by using the corresponding cross-correlating identifiers instead. These notifications can include, for example, notifications recommending that a secret asset be replaced due to the age of the secret asset, notifications identifying a risk or exposure associated with the secret assets, notifications regarding updates to information associated with the secret assets and other notifications.

In some instances, as shown, the other information stored for each security asset includes a time stamp(s) associated with deployment and/or use of the security asset, a status (e.g., valid or invalid status) of the security asset, a customer ID that identifies ownership of the security asset, instances of use where the security asset is being used in different systems, and other metadata that identifies types, restrictions, and other information associated with the use of the security asset. Additional information that can be included in the other metadata may also include contact information for users, administrators and other entities (e.g., third-party security asset managers) that are associated with deployment, storage and use of the security assets.

Finally, as also shown, the security asset index cross-correlating identifiers for each of the different security assets stored by the security asset database 200.

The Security Asset Manager 110 utilizes a cross-correlating ID generator 130 to generate the cross-correlating identifiers. The cross-correlating ID generator 130 generates the cross-correlating identifiers, in some instances, by creating a hash of each security asset in the security asset database 102.

In some implementations, the cross-correlating ID generator 130 utilizes a key generation algorithm, such as a secure hash algorithm (SHA), such as a SHA-1, SHA-2 or SHA-3 to generate a preliminary hash comprising the secure cross-correlating identifier corresponding to the security asset. Other types of key generation algorithms can also be used to generate a cross-correlating identifier that comprises a transformation of the security asset. Preferably, the cross-correlating identifier is no larger than 512 bits, 256 bits, 128 bits or a storage size smaller than 128 bits, to reduce the computational expense associated with generating, transmitting and utilizing the cross-correlating identifier.

In some instances, the cross-correlating identifier is smaller in size than the corresponding security asset. In other instances, the cross-correlating identifier is larger in storage size than the security asset, or at least contains more characters, so as to be a more secure representation than the security asset in terms of handling a brute force type discovery attack.

In some preferred embodiments, in order to further enhance the security of the cross-correlating identifier, the key generation algorithm may additionally generate a second hash that is based on the preliminary hash. The second hash may be a simple transformation of the preliminary hash, such as, for example, the upper-case form of the hexadecimal representation of the preliminary hash, salted with a well-known input string. The second hash can also undergo further transformations, such as a base 64 encoding to produce a file cross-correlating identifier that is highly defensible against reverse engineering brute force attacks directed at identifying the underlying security asset that corresponds to the generated cross-correlating identifier.

Once the cross-correlating identifier for a security asset is generated, it is stored in the security asset database 102 along with other security information associated with the corresponding security asset and without storing the security asset with the shareable cross-correlating identifier in the security asset database 102. In this manner, the distributed systems involved in the security asset management can share the security asset database 102 and the key generation algorithms with necessary entities (e.g., client systems) in secure and separate communications from the general notifications that are generated to communicate about and/or scan for compromised security assets using the cross-correlating identifiers and without exposing the underlying security assets in the subsequent communications and scanning processes. For instance, the security asset manager can send the cross-correlating identifiers to be used by remote and third-party scanning tools without exposing the actual security assets corresponding to the shared cross-correlating identifiers. Then, when a scanning process identifies the existence of potential security information matching the cross-correlating identifiers in scanned resources, the systems can notify the relevant entities that their security assets are compromised.

The security asset index 202 can also be shared with middleware systems that utilize the security asset index 202 to perform the scanning and security processes described herein, without exposing the underlying secrets of the actual security assets to the middleware systems.

In some instances, an administrative server system stores an additional and separate index (not shown, and which is securely stored in a key vault) that maps the cross-correlating identifiers to the actual security assets, in case a lookup by an administrator is ever needed to confirm security information.

In some instances, the Security Asset Manager 110 utilizes one or more local or remote security asset scan tool(s) 140 to scan the network-accessible resources 150 to identify potential security data containing the security assets identified in the security asset database 102.

The referenced security data patterns 104 include attributes of the security assets, which can be used to identify and distinguish the security assets from data that does not comprise security assets. In some instances, the security data patterns comprise actual words or terms that are used with the security assets or to identify the security assets, such as the terms “password,” “credential,” “username,” “SSN,” “ID,” “birthdate,” “code,” or other descriptive terms associated with a user's login credentials. Strings of characters, including letters, numbers and symbols are an additional example of a data pattern associated with potential security data.

In some instances, the security asset scan tool(s) 140 comprises or utilizes a machine learning model trained on training data comprising security assets of different types to identify potential security data identifiable from different types of resources (e.g., files, images, email communications, audio transcriptions, metadata).

The security asset scan tool(s) 140 access and parse different network-accessible resources 150 (e.g., Resource A, Resource B, Resource C) to scan for different potential security data containing a security asset, based on known security data patterns provided by the security asset manager 100 and/or accessible from various client or third-party indexes that identify security data patterns.

When the security asset scan tool(s) 140 identifies potential security data containing a security asset, the security asset manager 100 applies the algorithm(s), previously used by the cross-correlating ID generator 130 when generating the cross-correlating identifiers, to the potential security data containing the security asset to generate a reference identifier for that potential security data. Different reference identifiers can be generated for each instance of potential security data containing a security asset that is identified.

The security asset manager 100 then uses the newly generated reference identifiers, along with the cross-correlating identifiers that were previously generated and stored in the security asset database, to determine the associated security risks of the security assets stored in the security asset database 102. In some instances, the security asset manager 100 determines a security risk of the security asset based at least in part on the determination of whether the reference identifier matches the cross-correlating identifier.

In some embodiments, the security asset manager determines a security risk of the security asset based on the other information stored in the security asset database, such as the age of the security asset, detected uses of the security asset, a status of the security asset, and so forth.

The security risk associated with a security asset can be quantified as a binary value (e.g., High Risk or Low Risk) or as a numeric scaled value. A numeric scaled value, for example, can represent a calculated risk valuation generated as output from a model that is trained to apply weights to the information stored in the security asset database for the security assets in addition to any discovered use(s) of the security asset that is determined by finding matches between the reference identifiers and the cross-correlating identifiers for the potential security data.

The security risk can also be compared to a predetermined risk threshold that is established by an administrator or user. When the predetermined risk threshold is met or exceeded, the security asset manager 100 will trigger a remedial action.

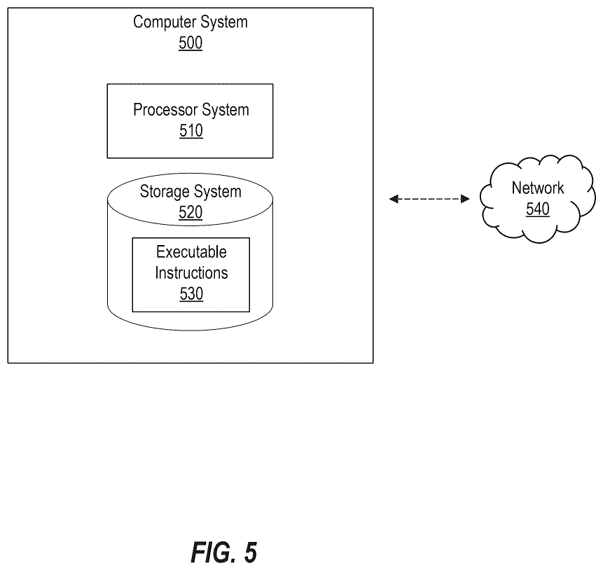

Attention is now directed to FIG. 3, which illustrates a processing flow 300 for managing security assets using cross-correlating identifiers, which may be implemented by the security asset manager 100 of FIG. 1 and which may be embodied in computing system 500 of FIG. 5.

As shown, the processing flow 300 includes accessing or generating a security asset database (processing block 310), such as security asset database 200 that was previously described in reference to FIG. 2. The processing flow 300 also includes generating the cross-correlating identifiers for the different security assets in the security asset database (processing block 320), such as by applying key generation algorithms to the security assets.

As noted above, the security asset database is then used with the cross-correlating identifiers to perform functions for the underlying security assets without exposing the security assets (325), as previously discussed.

One function that can be performed includes a security scan. The processing flow 300 has been prepared to illustrate how the cross-correlating identifiers can be used to perform a security scan for security assets without having to expose the underlying secrets of the security assets.

In this example, network resources are scanned for potential security data that matches security data patterns (processing block 330), as previously described. When potential security data is identified that matches a known security data pattern, it is processed by applying the key generation algorithms to generate a corresponding reference identifier that can be compared to the cross-correlating identifiers for the different security assets. Notably, this comparison can occur without having to share or otherwise expose the actual value of the underlying security asset.

When a match is found between a reference identifier and a cross-correlating identifier, it is determined that the security asset corresponding to the cross-correlating identifier has definitively been used in the identified instance of the potential security data. Based on this detected use of the security asset, the security risk for the security asset is determined (processing block 350). In some instances, a single detected use of the security asset in a scanned network resource is enough to determine the security risk for a security asset exceeds a predetermined risk threshold sufficient to warrant a remedial action (e.g., invalidating the security asset). In other instances, the risk only exceeds a predetermined threshold when the use of the security asset exceeds is used in a particular way, by a particular entity and/or in a particular type of resource.

The determined security risk of the security asset can be tracked in the metadata stored for the security asset in the security asset database based on any detected uses of the security asset. The determined security risk of the security asset can also be updated when new uses of the security asset are detected, based on new occurrences of the corresponding cross-correlating identifer matching reference identifiers of potential security data scanned in network resources.

When the security risk of a stored security asset exceeds a predetermined threshold, a remedial action is triggered. The remedial action includes, in some instances, the invalidation of the security asset, notifying an entity associated with the security asset, the replacement of the security asset with a new security asset (processing block 350), and/or other remedial actions (e.g., terminating sessions, closing applications, disabling functions).

In some instances, the replacement of a security asset can also be triggered independently of any determination about whether or not a reference identifier of a potential security data matches a cross-correlating identifier of the security asset. For instance, a determined age or use of the security asset, alone or in combination with other risk factors, can be used as a basis for making a determination that the security asset has a security risk that exceeds a predetermined security risk threshold for triggering the replacement of the security asset stored in the security asset database.

Attention will now be directed to the flowchart 400 of FIG. 4, which illustrates various acts that are associated with the disclosed methods and functionality described herein and which collectively illustrate a specific example for performing a function for a security asset, with a corresponding cross-correlating identifier, without exposing the underlying security asset. In this specific example, a security scan is performed for a security asset by using the corresponding cross-correlating identifer for the security asset and without exposing the security asset. Although the method acts may be discussed in a certain order or illustrated as occurring in a particular order, no particular ordering is required unless specifically stated or required because an act is dependent on another act being completed prior to the act being performed.

It is also noted that the acts reflected in the flowchart 400 Method 400 can be implemented by any of the systems described herein, such as the security asset manager 100 and computing system 500.

The acts shown in FIG. 4 have been previously described and include a computing system storing a security asset such as an account access credential in a security asset database with a corresponding cross-correlating identifier generated from a key generation algorithm (act 410). This may include generating the security asset database and storing information associated with the security assets along with the corresponding cross-correlating identifiers in the security asset database. The storage of this information also includes, in some instances, the actual generation of the cross-correlating identifiers for the security assets.

Different techniques can be used to generate the cross-correlating identifiers. In some instances, the generation of a cross-correlating identifier includes (i) the generation of a first hash of a security asset, (ii) the generation of a secondary hash of first hash, and (iii) encoding a predetermined number of bits of the secondary hash as the cross-correlating identifier for the security asset, as previously described.

The computing system also causes the scanning of network resources for potential security data (act 420). This scanning can be performed locally to the computing system with scanning tools of the computing system. The scanning can also be performed by scanning tools that are accessible to the computing system but remotely stored from the computing system.

The network resources can be targeted resources scanned in response to specific user commands. In some instances, the scanning of network resources is performed as part of an audit or periodic security management process for resources in a particular domain being managed.

The computing system scans for potential security data that matches security data profiles that are determined to correspond to security assets. When potential security data is identified, the computing system generates reference identifiers for the potential security data by applying the same key generation algorithms to the security data that were previously used to generate the cross-correlating identifiers (act 430).

The computing system also determines whether the reference identifiers match any cross-correlating identifier(s) in the security asset database (act 440).

Upon finding a match between a reference identifier and a cross-correlating identifier of a security asset, the computing system determines a security risk of the security asset (act 450). In some instances, the determination of the security risk is based solely on the determination of whether the reference identifier matches the cross-correlating identifier. In other instances, the determination of the security risk is based at least in part on the determination of whether the reference identifier matches the cross-correlating identifier in combination with other information stored in the security asset database, such as an age of the security asset, an identified presence of the security asset in an alert associated with malware and/or a publication of the security asset that is not authorized by the one or more entities associated with the security asset.

In response to a determination that the security asset comprises a security risk that exceeds a predetermined risk threshold, the computing system triggers a remedial action (act 460).

In some instances, the remedial action includes generating a notification to one or more entities associated with the security asset based on entity identification data stored in the security asset database and that is identified with the use of the cross-correlating identifier, the notification identifying the security risk and optionally providing instructions for replacing the security asset with a new security asset in one or more secret manager instances.

When performing a remedial action that includes invalidating an existing security asset, the computing system will obtain a new security asset and generate and store a new cross-correlating identifier for the new security asset.

In some embodiments, the computing system determines that a generated reference identifier fails to match any cross-correlating identifiers stored in the cross-correlating identifier data structure and refrains from replacing the cross-correlating identifiers responsive to determining that there is no match between the cross-correlating identifiers and the generated reference identifiers.

In an alternative embodiment, to reduce a potential staleness of the cross-correlating identifiers and the corresponding security asset, the system may trigger the replacement of a cross-correlating identifier (in response to determining that the cross-correlating identifier is associated with a timestamp or other temporal identifier such as a temporal identifier in the security asset index 202) that exceeds a predetermined age or timing threshold. This process can be performed independently of and/or in addition the previous process for comparing generated reference identifiers to the cross-correlating identifiers. When a determination is made to replace a cross-correlating identifer and corresponding security asset based on a time attribute associated with the cross-correlating identifer, a separate index (such as an index in a key vault) that correlates the cross-correlating identifier to a security asset can be used to identify the security asset that should also be replaced. A notification may be sent to an entity that manages the security asset to generate a new security asset when it is determined that the security asset should be replaced. Then, after the security asset is replaced, the computing system will generate a new cross-correlating identifier for the replacement security asset and the system will store the new cross-correlating identifier within the security asset database, separately from and without storing the replacement security asset in that same security asset database, such that the replacement security asset secret is not exposed within the security asset database (as previously described).

Attention will now be directed to FIG. 5, which illustrates an example computing system 500 that may include and/or be used to perform any of the operations described herein. For instance, computer system 500 can implement any of the functionality described herein and may incorporate the security asset manager 100, the security asset generator 120, the cross-correlating ID generator 130 and the security asset scan tool(s) 140 described in reference to FIG. 1.

Computing system 500 may take various different forms. For example, computing system 500 may be embodied as a tablet, a desktop, a laptop, a mobile device, or a standalone device, such as those described throughout this disclosure. Computing system 500 may also be a distributed system that includes one or more connected computing components/devices that are in communication with computing system 500.

In its most basic configuration, computing system 500 includes various different components. FIG. 5 shows that computing system 500 includes a processor system 510 that includes one or more processors (aka a “hardware processing unit”) and a storage system 520.

Regarding the hardware processor(s) of the processor system 510, it will be appreciated that the functionality described herein can be performed, at least in part, by one or more hardware logic components. For example, and without limitation, illustrative types of hardware logic components/processors that can be used include Field-Programmable Gate Arrays (“FPGA”), Program-Specific or Application-Specific Integrated Circuits (“ASIC”), Program-Specific Standard Products (“ASSP”), System-On-A-Chip Systems (“SOC”), Complex Programmable Logic Devices (“CPLD”), Central Processing Units (“CPU”), Graphical Processing Units (“GPU”), or any other type of programmable hardware.

As used herein, the terms “executable module,” “executable component,” “component,” “module,” “service,” or “engine” can refer to hardware processing units or to software objects, routines, or methods that may be executed on computing system 500. The different components, modules, engines, and services described herein may be implemented as objects or processors that execute on computing system 500 (e.g. as separate threads).

Storage system 520 may be physical system memory, which may be volatile, non-volatile, or some combination of the two. The term “memory” may also be used herein to refer to non-volatile mass storage such as physical storage media. If computing system 500 is distributed, the processing, memory, and/or storage capability may be distributed as well.

Storage system 520 is shown as including executable instructions 530. The executable instructions 530 represent instructions that are executable by the processor(s) of the processor system 510 to perform the disclosed operations, such as those described above.

The disclosed embodiments may comprise or utilize a special-purpose or general-purpose computer including computer hardware, such as, for example, one or more processors and system memory, as discussed in greater detail below. Embodiments also include physical and other computer-readable media for carrying or storing computer-executable instructions and/or data structures. Such computer-readable media can be any available media that can be accessed by a general-purpose or special-purpose computer system. Computer-readable media that store computer-executable instructions in the form of data are “physical computer storage media” or a “hardware storage device.” Furthermore, computer-readable storage media, which includes physical computer storage media and hardware storage devices, exclude signals, carrier waves, and propagating signals. On the other hand, computer-readable media that carry computer-executable instructions are “transmission media” and include signals, carrier waves, and propagating signals. Thus, by way of example and not limitation, the current embodiments can comprise at least two distinctly different kinds of computer-readable media: computer storage media and transmission media.

Computer storage media (aka “hardware storage device”) are computer-readable hardware storage devices, such as RAM, ROM, EEPROM, CD-ROM, solid state drives (“SSD”) that are based on RAM, Flash memory, phase-change memory (“PCM”), or other types of memory, or other optical disk storage, magnetic disk storage or other magnetic storage devices, or any other medium that can be used to store desired program code means in the form of computer-executable instructions, data, or data structures and that can be accessed by a general-purpose or special-purpose computer.

Computer system 500 may also be connected (via a wired or wireless connection) to external sensors (e.g., one or more remote cameras) or devices via a network 540. For example, computer system 500 can communicate with any number of devices or cloud services to obtain or process data. In some cases, network 540 may itself be a cloud network (e.g., the cloud shown in FIG. 1). Furthermore, computer system 500 may also be connected through one or more wired or wireless networks to remote/separate computer systems(s) that are configured to perform any of the processing described with regard to computer system 500.

A “network,” like network 540, is defined as one or more data links and/or data switches that enable the transport of electronic data between computer systems, modules, and/or other electronic devices. When information is transferred, or provided, over a network (either hardwired, wireless, or a combination of hardwired and wireless) to a computer, the computer properly views the connection as a transmission medium. Computer system 500 will include one or more communication channels that are used to communicate with the network 540. Transmissions media include a network that can be used to carry data or desired program code means in the form of computer-executable instructions or in the form of data structures. Further, these computer-executable instructions can be accessed by a general-purpose or special-purpose computer. Combinations of the above should also be included within the scope of computer-readable media.

Upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a network interface card or “NIC”) and then eventually transferred to computer system RAM and/or to less volatile computer storage media at a computer system. Thus, it should be understood that computer storage media can be included in computer system components that also (or even primarily) utilize transmission media.

Computer-executable (or computer-interpretable) instructions comprise, for example, instructions that cause a general-purpose computer, special-purpose computer, or special-purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the embodiments may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The embodiments may also be practiced in distributed system environments where local and remote computer systems that are linked (either by hardwired data links, wireless data links, or by a combination of hardwired and wireless data links) through a network each perform tasks (e.g. cloud computing, cloud services and the like). In a distributed system environment, program modules may be located in both local and remote memory storage devices.

The present invention may be embodied in other specific forms without departing from its characteristics. The embodiments described are to be considered in all respects only as illustrative and not restrictive. The scope of the invention is, therefore, indicated by the appended claims rather than by the foregoing description. All changes which come within the meaning and range of equivalency of the claims are to be embraced within their scope.

The present invention can also be described in accordance with the following numbered clauses.

Clause 1. A method for facilitating management of network security with cross-correlating secret keys, the method comprising: generating a security asset database for storing security assets that are used to control access to protected resources; creating a cross-correlating identifier for a security asset with a key generation algorithm; storing the cross-correlating identifier for the security asset in the security asset database with one or more other cross-correlating identifiers generated by the key generation algorithm for other security assets and without storing the secret asset in the security asset database; and utilizing the cross-correlating identifier to perform a process for the underlying security asset without exposing the security asset.

Clause 2. The method of clause 1, wherein the creation of the cross-correlating identifier includes (i) the generation of a first hash of the security asset, (ii) the generation of a secondary hash of first hash, and (iii) encoding a predetermined number of bits of the secondary hash as the cross-correlating identifier.

Clause 3. The method of clause 1, wherein the process performed with the cross-correlating identifier for the security asset comprises the generation of an index or graph that references the security asset with the cross-correlating identifier and without exposing the security asset.

Clause 4. The method of clause 1, wherein the process performed with the cross-correlating identifier for the underlying security asset comprises the generation of a notification that references the security asset with the cross-correlating identifier and without exposing the security asset.

Clause 5. The method of clause 1, wherein the process performed with the cross-correlating identifier for the security asset comprises a security scan for potential exposure of the security asset in network resources, the method further comprising: scanning the network resources for potential security data, the potential security data having a pattern matching one or more predetermined security data patterns; applying the key generation algorithm to the potential security data to generate a reference identifier; determining whether the reference identifier matches the cross-correlating identifier for the security asset or any of the one or more other cross-correlating identifiers stored in the security asset database; determining a security risk of the security asset based at least in part on the determination of whether the reference identifier matches the cross-correlating identifier; and in response to a determination that the security asset comprises a security risk that exceeds a predetermined risk threshold, triggering a remedial action.

Clause 6. The method of clause 5, wherein the remedial action includes generating a notification to one or more entities associated with the security asset based on entity identification data stored in the security asset database and that is identified with the use of the cross-correlating identifier, the notification identifying the security risk.

Clause 7. The method of clause 6, wherein the notification provides instructions for replacing the security asset with a new security asset in one or more secret manager instances.

Clause 8. The method of clause 5, wherein the method further includes generating and storing a new cross-correlating identifier for the new security asset.

Clause 9. The method of clause 5, wherein the method further comprises: determining the reference identifier fails to match the cross-correlating identifier for the security asset or any of the one or more other cross-correlating identifiers stored in the cross-correlating identifier data structure; and notwithstanding the reference identifier failing to match the cross-correlating identifier for the security asset, triggering an action for replacing the security asset with a replacement security asset, generating a new cross-correlating identifier for the replacement security asset, and storing the new cross-correlating identifier in the cross-correlating identifier data structure. receiving a replacement security asset from one or more entities associated with the security asset after triggering the action for replacing the security asset; and generating a cross-correlating identifier for the replacement security asset.

Clause 10. A computing system comprising: one or more processors; and one or more hardware storage device storing computer-executable instructions which are executable by the one or more processors for causing the computing system to implement a method for facilitating management of network security with cross-correlating secret keys, wherein the method comprises the computing system: generating a security asset database for storing security assets that are used to control access to protected resources; creating a cross-correlating identifier for a security asset with a key generation algorithm; storing the cross-correlating identifier for the security asset in the security asset database with one or more other cross-correlating identifiers generated by the key generation algorithm for other security assets and without storing the secret asset in the security asset database; and utilizing the cross-correlating identifier to perform a process for the underlying security asset without exposing the security asset

Clause 11. The computing system of clause 10, wherein the creation of the cross-correlating identifier includes (i) the generation of a first hash of the security asset, (ii) the generation of a secondary hash of first hash, and (iii) encoding a predetermined number of bits of the secondary hash as the cross-correlating identifier.

Clause 12. The computing system of clause 10, wherein the process performed with the cross-correlating identifier for the security asset comprises the generation of an index or graph that references the security asset with the cross-correlating identifier and without exposing the security asset.

Clause 13. The computing system of clause 10, wherein the process performed with the cross-correlating identifier for the underlying security asset comprises the generation of a notification that references the security asset with the cross-correlating identifier and without exposing the security asset.

Clause 14. The computing system of clause 10, wherein the process performed with the cross-correlating identifier for the security asset comprises a security scan for potential exposure of the security asset in network resources, the method further comprising: scanning network resources for potential security data, the potential security data having a pattern matching one or more predetermined security data patterns; applying the key generation algorithm to the potential security data to generate a reference identifier; determining whether the reference identifier matches the cross-correlating identifier for the security asset or any of the one or more other cross-correlating identifiers stored in the security asset database; determining a security risk of the security asset based at least in part on the determination of whether the reference identifier matches the cross-correlating identifier; and in response to a determination that the security asset comprises a security risk that exceeds a predetermined risk threshold, triggering a remedial action.

Clause 15. The computing system of clause 14, wherein the remedial action includes generating a notification to one or more entities associated with the security asset, the notification identifying the security risk and providing instructions for replacing the security asset with a new security asset in one or more secret manager instances and wherein the method further includes generating and storing a new cross-correlating identifier for the new security asset.

Clause 16. The computing system of clause 14, wherein the method further includes determining the security asset comprises the security risk that exceeds the security threshold based at least on age information stored in the security asset database associated with the security asset.

Clause 17. The computing system of clause 14, wherein the method further includes determining the security asset comprises the security risk that exceeds the security threshold based at least on an identification of the security asset in an alert associated with a use or publication of the security asset that is not authorized by the one or more entities associated with the security asset.

Clause 18. The computing system of clause 14, wherein the security asset comprises an account access credential.

Clause 19. The computing system of clause 14, wherein the method further comprises: determining the reference identifier fails to match the cross-correlating identifier for the security asset or any of the one or more other cross-correlating identifiers stored in the cross-correlating identifier data structure; and notwithstanding the reference identifier failing to match the cross-correlating identifier for the security asset, triggering an action for replacing the security asset with a replacement security asset, generating a new cross-correlating identifier for the replacement security asset, and storing the new cross-correlating identifier in the cross-correlating identifier data structure.

Clause 20. The computing system of clause 19, wherein the method further comprises: receiving a replacement security asset from one or more entities associated with the security asset after triggering the action for replacing the security asset; and generating a cross-correlating identifier for the replacement security asset.

What is claimed is:

1. A method for facilitating management of network security with cross-correlating secret keys, the method comprising:
generating a security asset database for storing security assets that are used to control access to protected resources;
creating a cross-correlating identifier for a security asset with a key generation algorithm;
storing the cross-correlating identifier for the security asset in the security asset database with one or more other cross-correlating identifiers generated by the key generation algorithm for other security assets and without storing the secret asset in the security asset database; and
utilizing the cross-correlating identifier to perform a process for the underlying security asset without exposing the security asset.

2. The method of claim 1, wherein the creation of the cross-correlating identifier includes (i) the generation of a first hash of the security asset, (ii) the generation of a secondary hash of first hash, and (iii) encoding a predetermined number of bits of the secondary hash as the cross-correlating identifier.

3. The method of claim 1, wherein the process performed with the cross-correlating identifier for the security asset comprises the generation of an index or graph that references the security asset with the cross-correlating identifier and without exposing the security asset.

4. The method of claim 1, wherein the process performed with the cross-correlating identifier for the underlying security asset comprises the generation of a notification that references the security asset with the cross-correlating identifier and without exposing the security asset.

5. The method of claim 1, wherein the process performed with the cross-correlating identifier for the security asset comprises a security scan for potential exposure of the security asset in network resources, the method further comprising:
scanning the network resources for potential security data, the potential security data having a pattern matching one or more predetermined security data patterns;
applying the key generation algorithm to the potential security data to generate a reference identifier;
determining whether the reference identifier matches the cross-correlating identifier for the security asset or any of the one or more other cross-correlating identifiers stored in the security asset database;
determining a security risk of the security asset based at least in part on the determination of whether the reference identifier matches the cross-correlating identifier; and
in response to a determination that the security asset comprises a security risk that exceeds a predetermined risk threshold, triggering a remedial action.

6. The method of claim 5, wherein the remedial action includes generating a notification to one or more entities associated with the security asset based on entity identification data stored in the security asset database and that is identified with the use of the cross-correlating identifier, the notification identifying the security risk.

7. The method of claim 6, wherein the notification provides instructions for replacing the security asset with a new security asset in one or more secret manager instances.

8. The method of claim 5, wherein the method further includes generating and storing a new cross-correlating identifier for the new security asset.

9. The method of claim 5, wherein the method further comprises:
determining the reference identifier fails to match the cross-correlating identifier for the security asset or any of the one or more other cross-correlating identifiers stored in the cross-correlating identifier data structure; and
notwithstanding the reference identifier failing to match the cross-correlating identifier for the security asset, triggering an action for replacing the security asset with a replacement security asset, generating a new cross-correlating identifier for the replacement security asset, and storing the new cross-correlating identifier in the cross-correlating identifier data structure. receiving a replacement security asset from one or more entities associated with the security asset after triggering the action for replacing the security asset; and
generating a cross-correlating identifier for the replacement security asset.

10. A computing system comprising:
one or more processors; and
one or more hardware storage device storing computer-executable instructions which are executable by the one or more processors for causing the computing system to implement a method for facilitating management of network security with cross-correlating secret keys, wherein the method comprises the computing system:
generating a security asset database for storing security assets that are used to control access to protected resources;
creating a cross-correlating identifier for a security asset with a key generation algorithm;
storing the cross-correlating identifier for the security asset in the security asset database with one or more other cross-correlating identifiers generated by the key generation algorithm for other security assets and without storing the secret asset in the security asset database; and
utilizing the cross-correlating identifier to perform a process for the underlying security asset without exposing the security asset

11. The computing system of claim 10, wherein the creation of the cross-correlating identifier includes (i) the generation of a first hash of the security asset, (ii) the generation of a secondary hash of first hash, and (iii) encoding a predetermined number of bits of the secondary hash as the cross-correlating identifier.

12. The computing system of claim 10, wherein the process performed with the cross-correlating identifier for the security asset comprises the generation of an index or graph that references the security asset with the cross-correlating identifier and without exposing the security asset.

13. The computing system of claim 10, wherein the process performed with the cross-correlating identifier for the underlying security asset comprises the generation of a notification that references the security asset with the cross-correlating identifier and without exposing the security asset.

14. The computing system of claim 10, wherein the process performed with the cross-correlating identifier for the security asset comprises a security scan for potential exposure of the security asset in network resources, the method further comprising:
scanning network resources for potential security data, the potential security data having a pattern matching one or more predetermined security data patterns;
applying the key generation algorithm to the potential security data to generate a reference identifier;
determining whether the reference identifier matches the cross-correlating identifier for the security asset or any of the one or more other cross-correlating identifiers stored in the security asset database;
determining a security risk of the security asset based at least in part on the determination of whether the reference identifier matches the cross-correlating identifier; and
in response to a determination that the security asset comprises a security risk that exceeds a predetermined risk threshold, triggering a remedial action.

15. The computing system of claim 14, wherein the remedial action includes generating a notification to one or more entities associated with the security asset, the notification identifying the security risk and providing instructions for replacing the security asset with a new security asset in one or more secret manager instances and wherein the method further includes generating and storing a new cross-correlating identifier for the new security asset.

16. The computing system of claim 14, wherein the method further includes determining the security asset comprises the security risk that exceeds the security threshold based at least on age information stored in the security asset database associated with the security asset.

17. The computing system of claim 14, wherein the method further includes determining the security asset comprises the security risk that exceeds the security threshold based at least on an identification of the security asset in an alert associated with a use or publication of the security asset that is not authorized by the one or more entities associated with the security asset.

18. The computing system of claim 14, wherein the security asset comprises an account access credential.

19. The computing system of claim 14, wherein the method further comprises:
determining the reference identifier fails to match the cross-correlating identifier for the security asset or any of the one or more other cross-correlating identifiers stored in the cross-correlating identifier data structure; and
notwithstanding the reference identifier failing to match the cross-correlating identifier for the security asset, triggering an action for replacing the security asset with a replacement security asset, generating a new cross-correlating identifier for the replacement security asset, and storing the new cross-correlating identifier in the cross-correlating identifier data structure.

20. The computing system of claim 19, wherein the method further comprises:
receiving a replacement security asset from one or more entities associated with the security asset after triggering the action for replacing the security asset; and
generating a cross-correlating identifier for the replacement security asset.
